(19) United States
(12) Patent Application Publication
(10) Pub. No.: US 2006/0195566 A1
(43) Pub. Date: Aug. 31, 2006

(54) Method and system for taking remote inventory in a network

(76) Inventor: Mark Edward Hurley, Glen Burnie, MD (US)

Correspondence Address: DLA PIPER RUDNICK GRAY CARY US LLP, P. O. BOX 9271, RESTON, VA, 20195, US

(21) Appl. No.: 11/064,949

(22) Filed: Feb. 25, 2005

(51) Int. Cl. G06F 15/173

(52) U.S. Cl. 709/224

(57) ABSTRACT

A method of monitoring a network is provided, the method comprising scanning hosts across the network for information related to functioning services and applications, wherein at least one host/device utilizes anti-virus software and other software; and gathering and summarizing information from the host.

### FIELD OF THE INVENTION

The present invention relates generally to monitoring a network, and relates specifically to taking inventory in a network.

### BRIEF DESCRIPTION OF THE DRAWINGS

FIG. 1 illustrates an overview system of a scanning tool, according to one embodiment of the invention.

FIGS. 2-4 illustrate a method of taking inventory of applications running on hosts/devices in a network, according to one embodiment of the invention.

FIGS. 5-8 are screen shots illustrating a scanning tool, according to one embodiment of the invention.

FIG. 9 illustrates examples depicting definitions of compliance for a scanning tool, according to one embodiment of the invention.

### DESCRIPTION OF EMBODIMENTS OF THE INVENTION

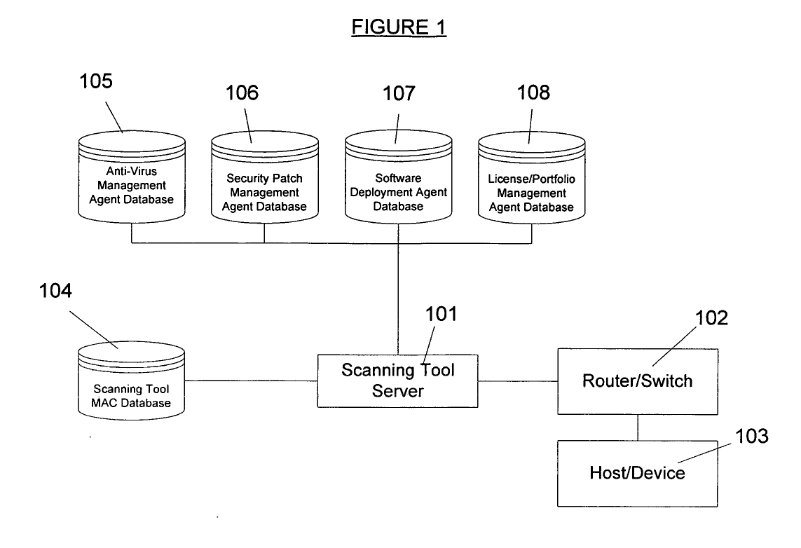

FIG. 1 illustrates an overview system of a scanning tool, according to one embodiment of the invention. A scanning tool server(s) 101, running the scanning tool, connects to a perimeter(s), network router(s) or Local Area Network (LAN) switch(es) 102 and retrieves a listing of connected hosts/devices 103. The listing of connected hosts/devices 103 includes the Media Access Controller (MAC) address and Internet Protocol (IP) address. For each host/device 103 in the list, the scanning tool server 101 examines the network services of the host/device 103 using the IP Address. The scanning tool server 101 attempts to determine the Operating System (OS) of the remote host/device 103. The OS information is used to determine which applications should be installed on the remote system. Applications, referred to as “Agents”, include, but are not limited to: an Anti-Virus Management Agent (e.g., EPO) 105, a Security Patch Management Agent (e.g., Big Fix) 106, a Software Deployment Agent (e.g., Tivoli) 107, and a Software License/Portfolio Management Agent (e.g., Asset Insight) 108. An Anti-Virus Management Agent 105 is installed on a computer for the purpose of managing/maintaining anti-virus software and anti-virus definitions/updates. A Security Patch Management Agent 106 is installed on a computer for the purpose of maintaining security patches. A Software Deployment Agent 107 is installed on a computer for the purpose of receiving and installing software from a remote server. A License/Portfolio Management Agent 108 is used to track installed software applications. The scanning tool server 101 evaluates these agents and determines if one or more agents is missing according to software guidelines instituted by the enterprise. The host/device 103 does not need special software installed on the host/device 103 to be able to provide information about the installed agents to the scanning tool server 101. Information keyed according to the MAC address is retrieved from external agent databases 104-108 and is combined in the data analysis process. One or more user identification(s) are retrieved from the host/device 103, demonstrating the currently logged in users. The scanning tool server 101 inserts/updates data collected into the scanning tool MAC database(s) 104.

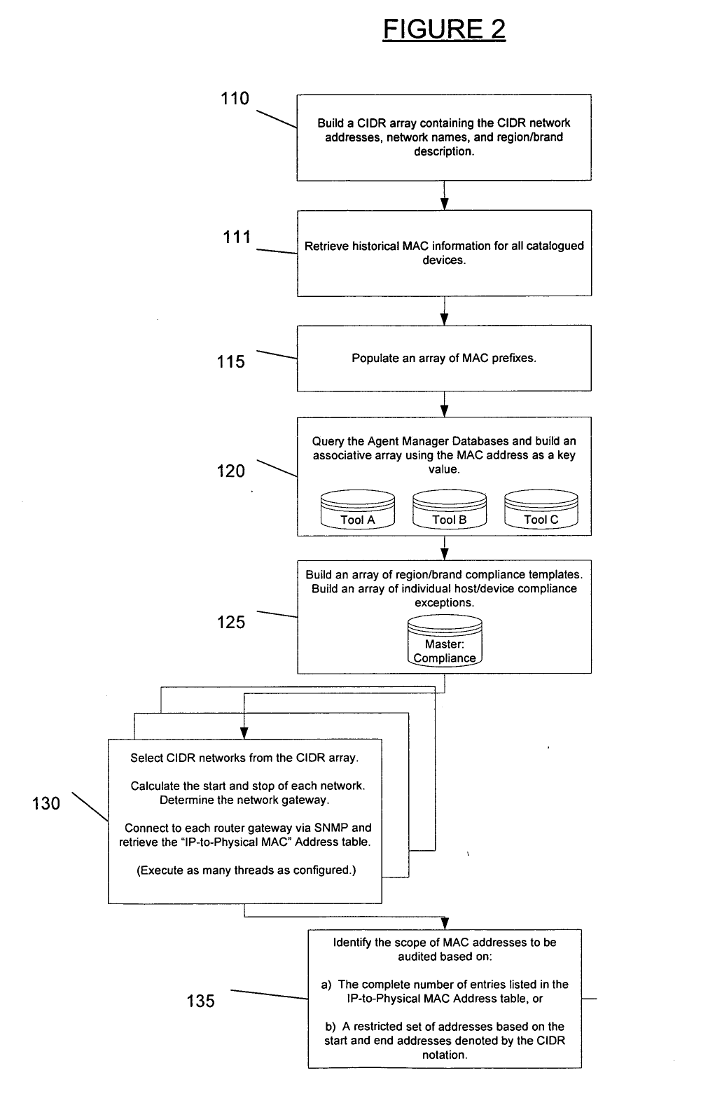

FIGS. 2-4 illustrate a method of taking inventory of agent applications running on hosts/devices 103 in a network, according to one embodiment of the invention. FIG. 2, step 110 illustrates a scanning tool server 101 building an array of network addresses associated with a Wide Area Network (WAN). The WAN addresses are provided and maintained by a network administrator using the scanning tool MAC database 104. The network addresses are stored in Classless Inter Domain Routing (CIDR) format. Each network array element contains a CIDR network address (e.g., 10.0.0.0/23 or 10.0.0.2/24), a unique network identifier, and a network description (e.g., name of the physical network location.) In step 111, historical Media Access Control (MAC) information for all catalogued hosts/devices 103 in the network is retrieved from the scanning tool MAC database 104 by the scanning tool server 101. Each network host/device 103 contains a MAC address which is maintained as a unique identifier for each connected host/device 103. Historical MAC information is historical host/device audit data, and can include: the date a host/device 103 was first identified, the date it was last audited, the most recent Operating System (OS) version detected, the last network to which a host/device 103 was connected, and the last compliance value. The compliance value is determined according to the prescribed software agents required for the networked host/device 103. A computer is considered compliant if the host/device 103 satisfactorily meets the software installation or agent requirements defined in a Compliance Template. A Compliance Template defines the software agents required according to each network. In step 115, an array of MAC addresses (i.e., the first six digits) is retrieved from the scanning tool MAC database 104 by the scanning tool server 101. The MAC addresses are determined by the Institute of Electrical and Electronics Engineers (IEEE), which maintains an Organizationally Unique Identifier (OUI) which is a six digit prefix unique to each hardware vendor. For each host/device 103 scanned, the tool evaluates the first six digits of the host/device MAC and attempts to associate the appropriate vendor with each host/device 103. In step 120, Agent Managers (external databases) 105-108 are queried by the scanning tool server 101 for MAC addresses. The Agent Manager data may be combined in the data analysis process to determine the status of an agent. The status includes recent agent/manager check-in times and current support levels (e.g., current patch levels and current anti-virus definitions). Agent information stores may include, but are not limited to: data representing the MAC address, the OS version, the OS type (e.g., server v. workstation), the last inventory date, the security patch level, an agent/manager host/device identifier, the anti-virus software engine version, and the anti-virus signature level.

In step 125, network Compliance Templates are retrieved from the scanning tool MAC database 104 by the scanning tool server 101. Compliance templates specify the agents that should be installed on each host/device 103 within the network. The scanning tool server 101 constructs an array of compliance requirements according to the various regional network locations. In addition, the scanning tool server 101 identifies any host/device-specific compliance templates which have been implemented in circumstances where a host/device 103 may not operate a specific agent software as a result of a software incompatibility, referred to as an “Exception”.

In step 130, CIDR networks are selected by the scanning tool server 101 from the CIDR array built in step 110 and stored in the scanning tool MAC database 104. The start and stop address of each network is calculated along with the network gateway. The network gateway is typically the beginning address of the network plus one. For example, the network CIDR address of 10.0.0.0/24 would have a start position of 10.0.0.0 and an end position of 10.0.0.255. In this illustration, the gateway address would be 10.0.0.1 (network plus one). The scanning tool server 101 calculation determines the typical network gateway and provides a range of addresses for a connected host/device 103 to properly transmit data across the gateway. The gateway address, which is configured to the router or switch, is queried to determine information such as the IP Address to MAC Address translation table (IP-to-MAC) and Ethernet port information. The Simple Network Management Protocol (SNMP) is one method used to obtain this information remotely. For example, the SNMP base Object Identifier .1.3.6.1.2.1.4.22.1.2 can be used to retrieve the IP-to-MAC information from a network router or switch. The scanning tool server 101 authenticates to the network gateway device and requests the IP-to-MAC information by presenting the SNMP OID to the network gateway device. The IP-to-MAC translation table for the connected hosts/devices 103 on the Local Area Network (LAN) is retrieved from the router or switch.

In step 135, the scope of MAC addresses to be audited is identified by the scanning tool server 101 based on the complete number of entries listed in the IP-to-MAC address table or a restricted set of addresses based on the start and end addresses denoted by the CIDR notation. For example, if a host/device MAC address was 10.0.1.5 on a gateway interface with a CIDR of 10.0.0.0/24, the host/device 103 would be included if all entries from the IP-to-MAC address table were included in the audit. However, if there is a restriction that the host/device address be within the range of the CIDR network (10.0.0.0/24), the host/device 103 would be excluded because it exceeds the value of the maximum host/device address (10.0.0.255). Thus, if the example is 10.0.0.0/24, the start is 10.0.0.0, and the end is 10.0.0.255. 10.0.1.5 is restricted because 10.0.1.5 exceeds 10.0.0.255 and is out of scope.

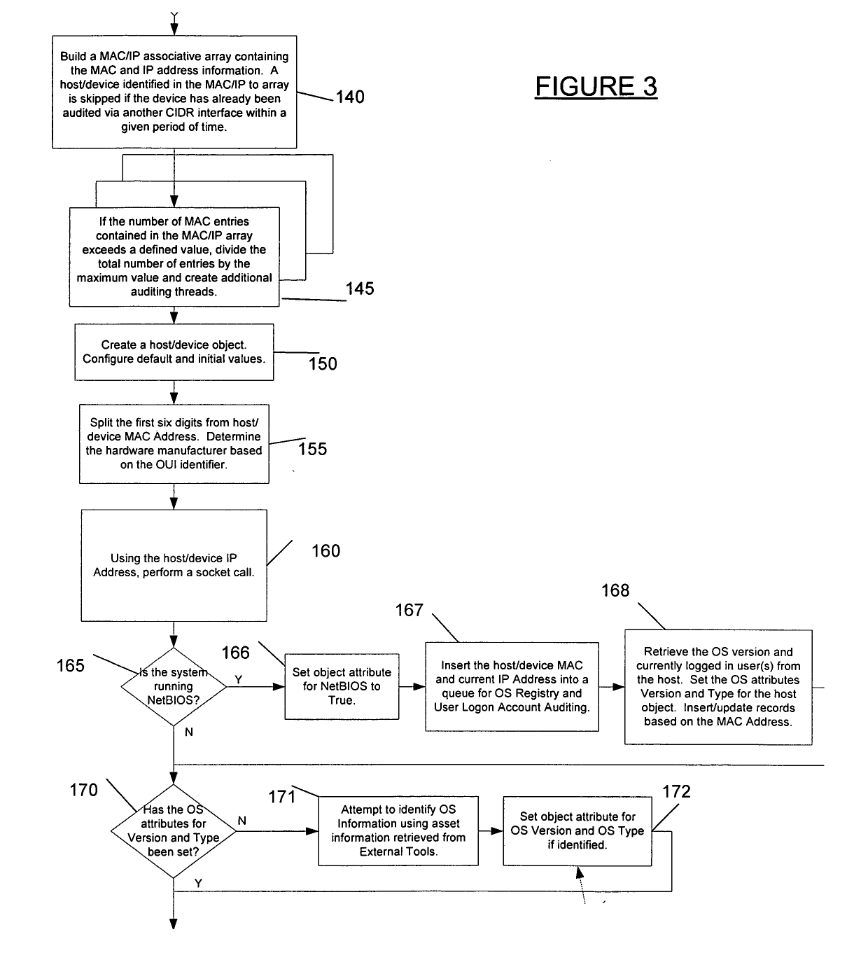

Turning to FIG. 3, where the flowchart of FIG. 2 is continued, in step 140 a MAC/IP associative array is built containing the MAC and IP address information collected from the network router/switch by the scanning tool server 101 utilizing information in the scanning tool MAC database 104. In one embodiment, a host/device 103 identified in the MAC/IP array is skipped if the host/device 103 has already been audited within a given period of time (e.g., a day). The frequency is determined based on a cache file which incorporates the date/time for data output. The cache file is appended with a host/device MAC when a host/device 103 has been audited, and is examined prior to auditing by another network router/device or session to ensure that a duplicate audit is not performed on a previously audited host/device 103.

In step 145, if the number of MAC entries contained in the MAC/IP array exceeds a defined maximum value, the total number of entries is divided by the defined maximum value and additional auditing threads are created by the scanning tool server 101.

In step 150, a host/device object is created by the scanning tool server 101 by instantiating (i.e., copying) each host/device 103 into an object. Host/device initial values and default values are configured. Initial values, including, but not limited to, network address range, network identification, network description, MAC address, and current IP address are configured for that host/device object. The network identification is used to determine what Compliance Template should be applied when evaluating the status of the installed agents on the host/device object. Additionally, the host/device object will inherit network data, such as the network description which may include geographic location or the name of the organization responsible for the host/device 103. The host/device object will contain the data inherited by the network in addition to the data captured by the scanning tool server 101.

In step 155, the first six digits are split from the host/device MAC address by the scanning tool server 101. The hardware manufacturer of the host/device 103 is determined from these first six digits of the MAC address using the IEEE OUI MAC prefixes obtained in FIG. 1, step 115. The manufacturer information is used to identify a class or brand of the host/device 103. For example, it is known that some manufacturers develop network infrastructure (e.g., routers and switches), while other manufacturers develop printers or thin clients. The manufacturer attribute, determined from the MAC address, is set within the host/device object at the time of the audit.

In step 160, the host/device IP address is used by the scanning tool server 101 to perform a socket call using the router/switch 102 and host/device 103. If the network is supported by Microsoft Windows, the Network Basic Input Output System (NetBIOS) protocol can be used, and a socket call can be placed to TCP/IP Port 139.

In step 165, the scanning tool server 101, using the network path of the router/switch 102, determines if host/device 103 is running NetBIOS, commonly used by devices running the Windows Operating System. If so, in step 166, object attributes for NetBIOS are set to true by the scanning tool server 101. In step 167, the host/device MAC and current IP address are inserted by the scanning tool server 101 into a queue which resides in the scanning tool MAC database 104. In step 168, a scanning tool server 101 retrieves recent (e.g., only records inserted within the last five minutes) IP-to-MAC entries from the queue contained on the scanning tool MAC database 104, and attempts to retrieve the OS version and type (workstation v. server) and the currently logged in user(s) from the host/device 103 using remote system calls. The OS version and host/device type are used to help identify target system types for enterprise software deployment and determine required software agents for compliance reporting. The external agent database OS information, obtained in step 120, is used as a fallback in the event a system cannot be accessed remotely. The process then moves to step 170.

If it is determined that the system is not running NetBIOS, the process moves directly to step 170, where it is determined by the scanning tool server 101, using the network path provided by router/switch 102, if the OS attributes for the version and type have been set for the host/device 103. If not, in step 171, the scanning tool server 101 attempts to identify OS information using asset information retrieved from external agent managers 105-108, obtained in step FIG. 2, step 120. In step 172, the object attribute for the OS version and the OS type is set by the scanning tool server 101, if identified. The process then moves to step 175.

If the OS attribute for the version and type have been set in step 170, the process moves directly to step 175.

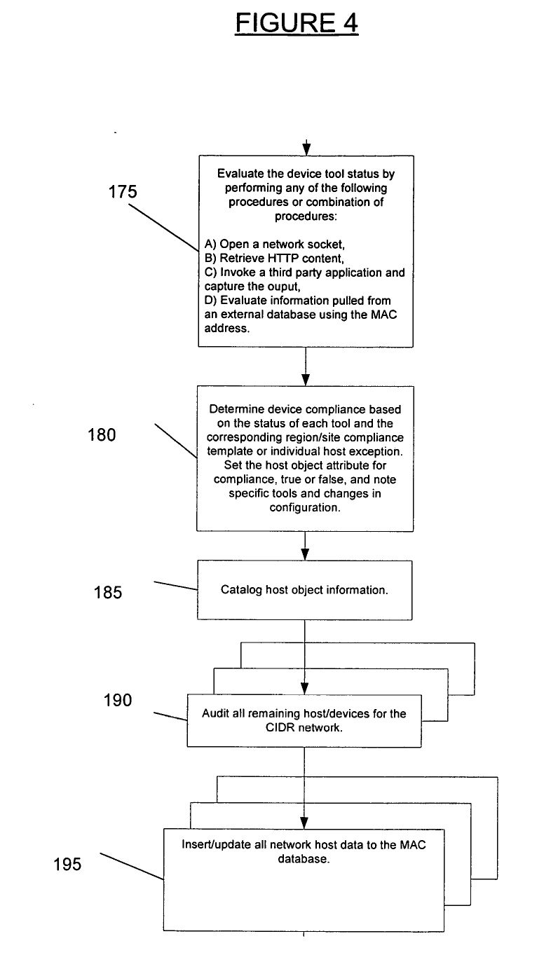

FIG. 4 continues the flowchart from FIGS. 2 and 3. In step 175, the status of agent applications on the host/device 103 is evaluated by the scanning tool server 101 through the router/switch 102 by performing any combination of the following procedures: A) opening a network socket; B) retrieving HyperText Transfer Protocol (HTTP) content; C) invoking a third party application and capturing the output; and/or D) evaluating information pulled from an external agent manager database by relation of the host/device MAC address. In opening a network socket, a TCP/IP socket call is performed to the host/device IP address and target port. If the port is listening, the application status is true. In retrieving HTTP content, the client has a listening TCP/IP port with an HTTP-based application services. An HTTP “get” function is performed to retrieve the software's configuration from the client. When a third party application is invoked, a remote connection to the host/device 103 is established and evaluated. A third party application may include, but is not limited to, a network TCP or UDP port scanner. The third party application is executed with the desired host/device IP address. The standard/error output is collected and evaluated. The status is true if the expected value is obtained. If the host/device being evaluated does not have a client listening port, or the method to obtain the information used in A, B, or C, is insufficient for determining the host/device status, the host/device MAC address is cross-referenced with an array built from information pulled from the external agent manager database, collected in FIG. 2, step 120. For example, if an agent application does not have a listening service port (e.g. TCP/IP, UDP) which may be evaluated, an identification of the host/device 103 in the external agent manager database may satisfy the compliance monitoring requirement. Additionally, the evaluation of a listening service port, determined as true, may not completely satisfy the agent operability until the host/device 103 has also been confirmed to be operational in the agent manager database, or vice versa. If the MAC address exists in the external agent manager database and the minimum application requirements are satisfied, the status is true.

In step 180, the host/device compliance is determined by the scanning tool server 101 utilizing the scanning tool MAC database 104 based on the status of each installed agent application and the corresponding network compliance template or individual host/device template. The host/device object attribute is set for compliance, at true or false, and specific agents and changes in configuration since the last audit are noted.

In step 185, host/device object information is stored temporarily until the scanning tool server 101 audits each host/device 103 identified in the network IP-to-MAC table. In step 190, all remaining host/devices 103 contained in the IP-to-MAC table are audited in the same manner described above. In step 195, all network host/device data is inserted/updated by the scanning tool server 101 to the scanning tool MAC database 104. In one embodiment, the database inserts/updates occur in a batched mode according to the network. Each network audit represents one thread. Multiple threads, representing multiple networks, are implemented, resulting in simultaneous network updates to the scanning tool MAC database 104.

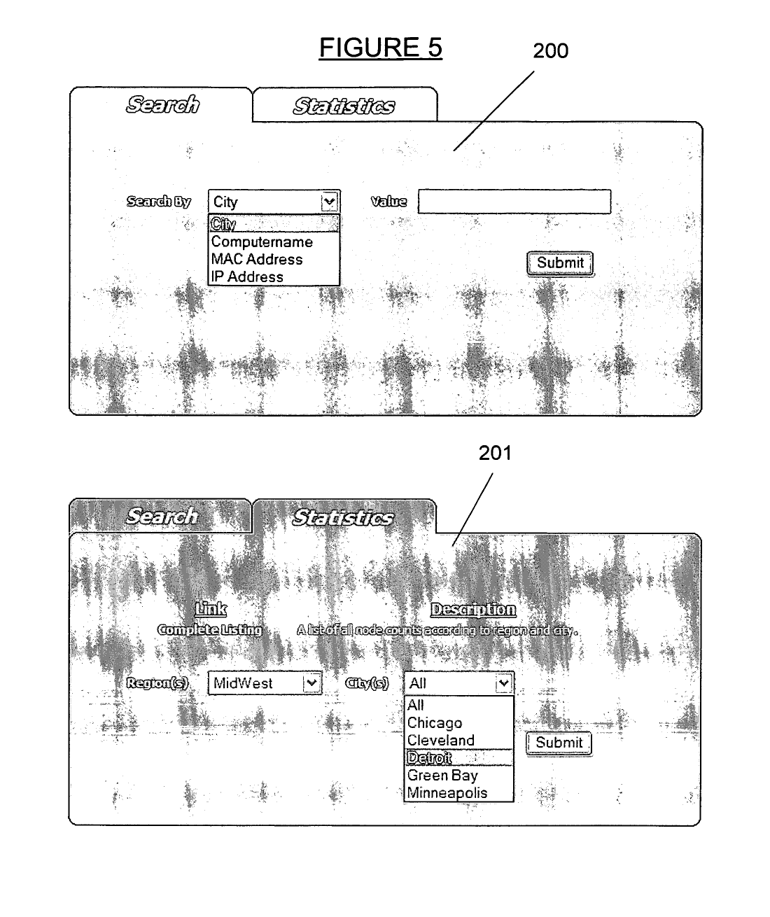

FIGS. 5-8 are screen shots illustrating use of a scanning tool, according to one embodiment of the invention. FIG. 5 illustrates a screen shot of a scanning tool interface 200 that is used to search the scanning tool MAC database 104 according to: City, Computername or Hostname, MAC Address, or IP Address. An interface 201 in FIG. 5 is used to select and report inventory and compliance statistics for networked offices, according to a geographic region and metropolitan area.

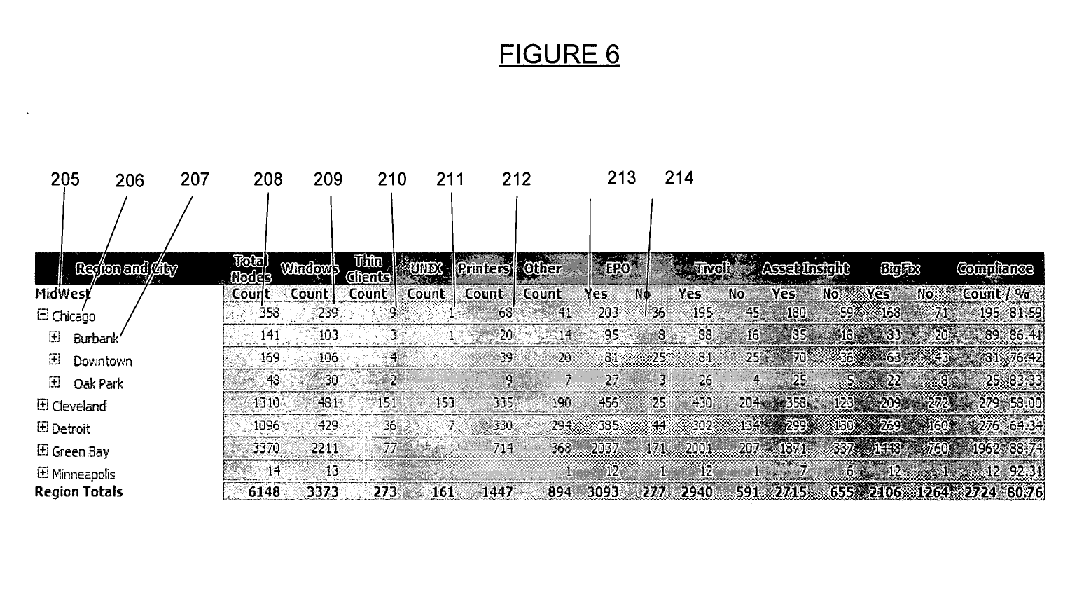

In FIG. 6, scanning tool reports are illustrated. Data is organized according to geographic location 205 and grouped according to a metropolitan area 206. In FIG. 6, the total count of networked hosts/devices identified in the MidWest region is 6,148. In this illustration, the MidWest region consists of five metropolitan areas: Chicago, Cleveland, Detroit, Green Bay, and Minneapolis. The Chicago 206 area contains a total of 358 (FIG. 6, 208) networked hosts/devices established within three area cities 207. Of the 358 networked hosts/devices in the Chicago area, 68 hosts/devices are printers 212, 9 hosts/devices are thin clients 210 or diskless stations, 1 host/device is a UNIX-based server 211, and 239 hosts/devices are Microsoft Windows-based computers 209. Each host/device category has distinct software compliance requirements. For example, UNIX-based systems will have different compliance auditing requirements than Microsoft Windows computers. Computers with a UNIX-based OS may utilize only one or two agents for software administration: a software distribution agent and security patch management agent. Computers operating a Windows-based OS, may require multiple agents: one agent may be required to manage anti-virus software, another agent may be required for managing security patches, another agent may installed for software deployment, and another agent may be installed to facilitate software license management. In FIG. 6, the report illustrates each of the total systems and the installed agents according to the four agent categories described within. For example, in the Chicago area, the total Windows-based computers with an anti-virus management agent is 203 (FIG. 6, 213); the total Windows-based computers without an anti-virus management agent is 36 (FIG. 6, 214). In this illustration, the scanning tool information demonstrates that certain hosts/devices do not possess the software agents required by the enterprise.

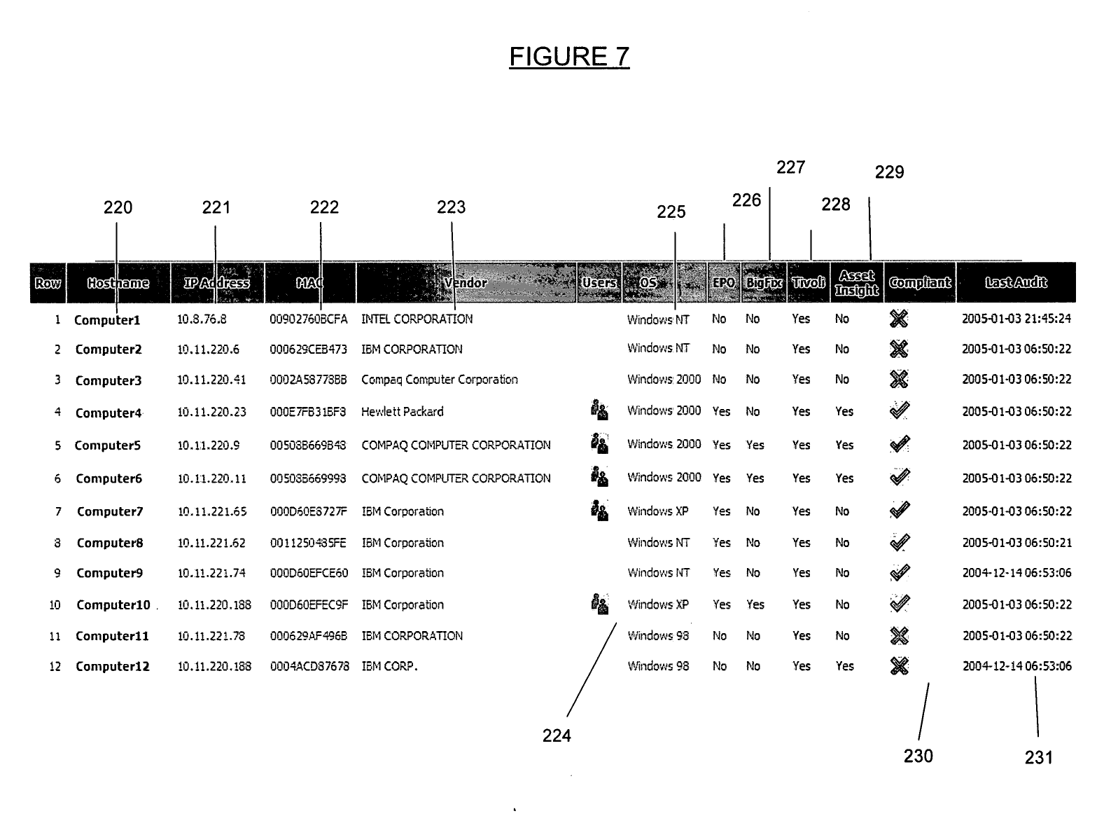

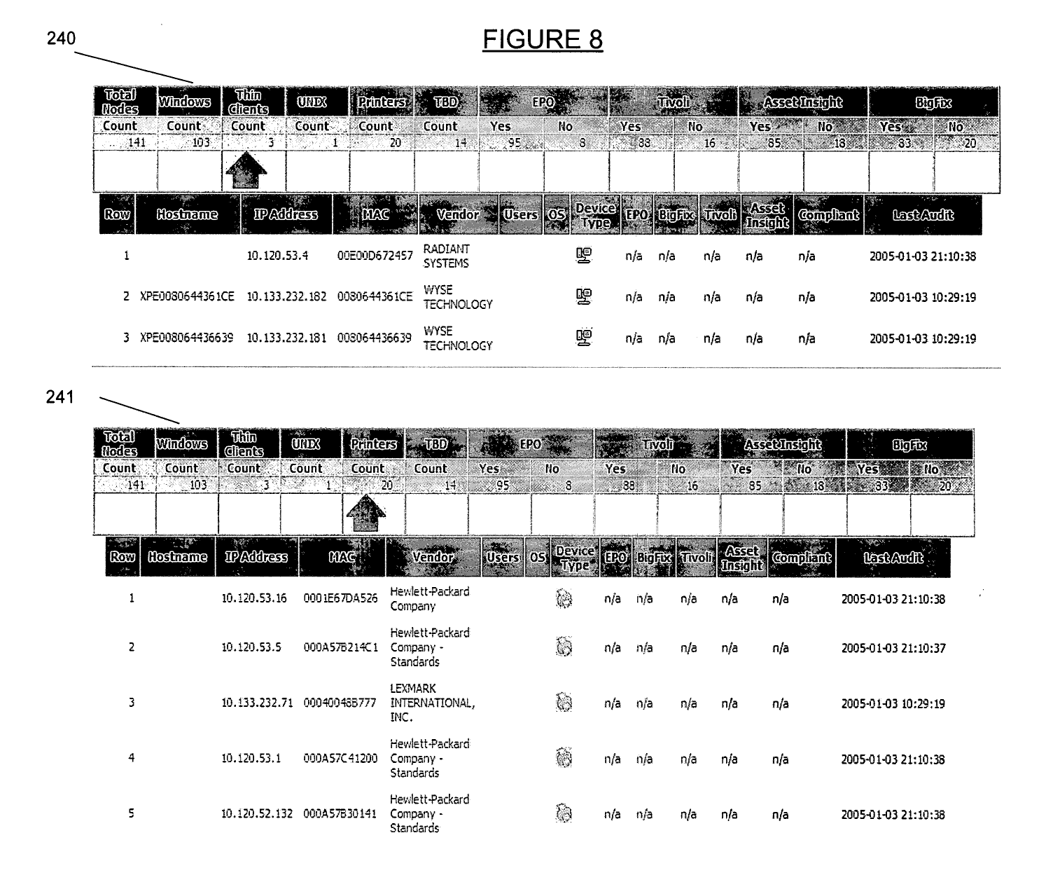

FIGS. 7-8 are illustrations of computers and other hosts/devices identified by the scanning tool. Each computer contained in FIG. 7 may contain a hostname 220, a recent IP address 221, a unique MAC address 222, a vendor label 223, a link to a list of user(s) recently logged-in 224, the OS version 225, agent status for anti-virus management 226 (e.g., ePolicy Orchestrator (EPO)), agent status for security patch management 227 (e.g., Big Fix), agent status for software deployment 228 (e.g., Tivoli), agent status for license/portfolio management 229 (e.g., Asset Insight), an overall host/device compliance value 230, and the date the host/device was last audited 231. FIG. 8 is an illustration of hosts/devices reported by the scanning tool, representing both Thin Clients 240 and Printers 241.

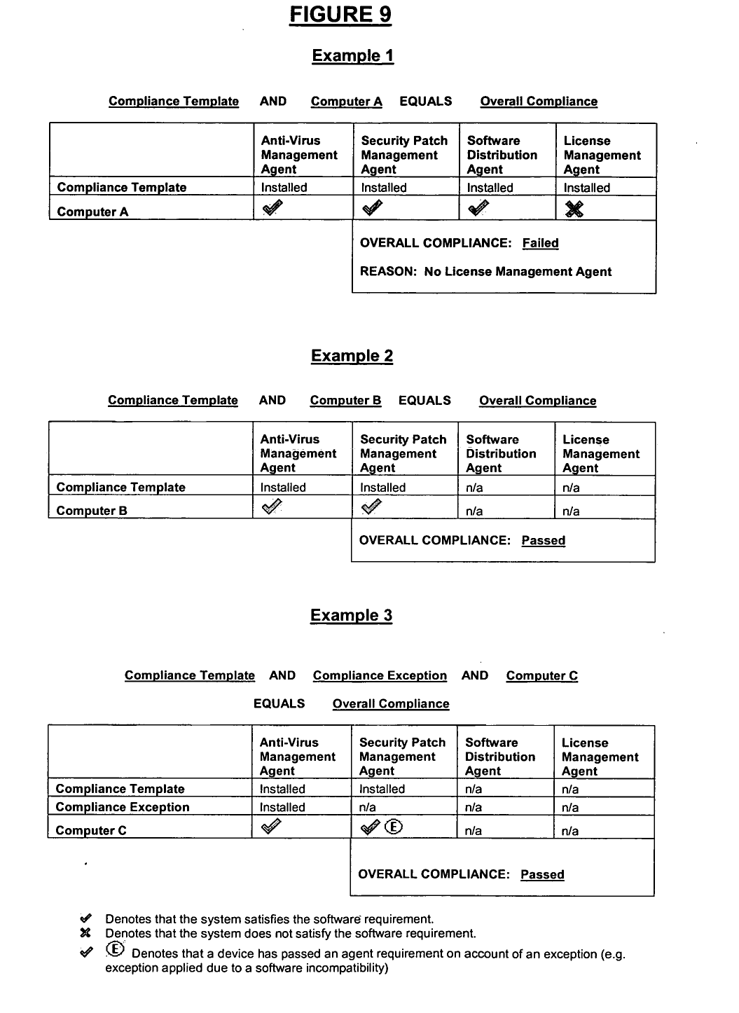

In FIG. 9, three examples are provided which illustrate the logic used by the scanning tool to determine host/device compliance according to a Compliance Template. The Compliance Template is a set of agent requirements assigned to a specific network or group of networks in a geographic location. In Example 1, the scanning tool identifies that Computer A is operating three (the Anti-Virus Management Agent, Security Patch Management Agent, and Software Distribution Agent) of the four required software agents required per the Compliance Template. According to the scanning tool results, Computer A will be reported as non-compliant until the fourth agent (License Management Agent) installation is satisfied. In Example 2, the Compliance Template dictates that two software agents must be installed: an Anti-virus Management Agent and a Security Patch Management Agent. Computer B has both agents installed and therefore the host/device has satisfied the Compliance Template requirements.

Individual host/device compliance may be evaluated in substitution for a network Compliance Template. In Example 3, a Compliance Exception provides an adjusted Compliance Template measurement. For example, Computer C requires that only one (Anti-Virus Management Agent) of the two software agents normally required by the Compliance Template be installed as a result of an Exception (designated by an E). The Security Patch Management Agent is an Exception in Computer C. Thus, because the Compliance Template has the Anti-Virus Management Agent installed, and an exception for the Security Patch Management Agent, the host/device passes the Compliance Template requirements.

### CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

In addition, it should be understood that the figures, which highlight the functionality and advantages of the present invention, are presented for example purposes only. The architecture of the present invention is sufficiently flexible and configurable, such that it may be utilized in ways other than that shown in the accompanying figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. A method of monitoring at least one network, comprising:
scanning at least one device across at least one network for information related to at least one application, including at least one application that is not an anti-virus software application; and
gathering and summarizing information related to the at least one application from the at least one scanned device.

2. The method of claim 1, wherein the at least one network is reviewed at least once a day.

3. The method of claim 1, further comprising comparing a compliance template formatted from each scanned device to determine if expected network configurations of the device are in compliance with requirements.

4. The method of claim 1, further comprising creating a MAC-to-IP address table from a router or switch and using a MAC address of the at least one device as a primary value for storing and relating all gathered and summarized information, and using an IP address of the at least one device to temporarily scan and collect system data across a Wide Area Network (WAN).

5. The method of claim 4, further comprising:
determining CIDR start and stop points for a desired network range in the MAC-to-IP address table; and
auditing only entries in the MAC-to-IP address table that fall within the start and stop points.

6. The method of claim 4, wherein all entries in the MAC-to-IP address table are audited.

7. A method of monitoring at least one network, comprising:
building an array of at least one CIDR network containing CIDR network address, network name, and description;
retrieving historical MAC information for at least one device catalogued in the at least one CIDR network;
building a MAC array of MAC prefixes;
building a compliance template including a compliance exception template;
for each selected CIDR network:
identifying a scope of MAC addresses to be audited in the selected CIDR array;
building a MAC-to-IP address table containing MAC and IP address information;
creating a device object containing information about each device IP address;
performing a socket call to each device IP address;
evaluating each device status;
cataloguing each device status; and
generating a report including the status of all catalogued devices in the network.

8. The method of claim 7, wherein the at least one network is reviewed at least once a day.

9. The method of claim 7, wherein the compliance template is used to determine if expected network configurations of the at least one device are in compliance with requirements, and the exception template is used to determine if the at least one device does not need to be in compliance with certain requirements.

10. The method of claim 7, wherein the MAC address is used as a primary value for storing and relating all gathered and summarized information from the at least one device.

11. The method of claim 10, further comprising:
determining CIDR start and stop points for a desired network range in the MAC-to-IP address table; and
auditing only entries in the MAC-to-IP address table that fall within the start and stop points.

12. The method of claim 10, wherein all entries in the MAC-to-IP address table are audited.

13. A method of monitoring at least one network, comprising:
crossing at least one wide area network to scan at least one device across the at least one network for information related to at least one application;
obtaining information from at least one database related to the at least one application; and
combining the information obtained from the at least one device and the at least one database to determine status information regarding the at least one application on the at least one device.

14. The method of claim 13, wherein the at least one network is reviewed at least once a day.

15. The method of claim 13, further comprising comparing a compliance template formatted from each scanned device to determine if expected network configurations of the at least one device are in compliance with requirements.

16. The method of claim 13, further comprising creating a MAC-to-IP address table and using the MAC address as a primary value for storing and relating all information.

17. The method of claim 16, further comprising:
determining CIDR start and stop points for a desired network range in the MAC-to-IP address table; and
auditing only entries in the MAC-to-IP address table that fall within the start and stop points.

18. The method of claim 16, wherein all entries in the MAC-to-IP address table are audited.

19. The method of claim 1, wherein the at least one application includes at least one enterprise software agent application.

20. The method of claim 13, wherein the at least one application includes at least one enterprise software agent application.
